(19) United States
(12) Patent Application Publication
(10) Pub. No.: US 2010/0308523 A1
(43) Pub. Date: Dec. 9, 2010

(54) Tool for installation of a pipe connection

(75) Inventor: Rainer Neumann, Herten (DE)

Correspondence Address: COLLARD & ROE, P.C., 1077 NORTHERN BOULEVARD, ROSLYN, NY, 11576, US

(73) Assignee: Vulkan Lokring-Rohrverbindungen GmbH & Co. KG

(21) Appl. No.: 12/455,607

(22) Filed: Jun. 4, 2009

(51) Int. Cl. B25B 1/06

(52) U.S. Cl. 269/240

(57) ABSTRACT

A tool for installation of a pipe connection that has a pipe connection sleeve and two pinch collets that can be pressed onto it. The tool has two clamping jaws oriented parallel to one another, which can move relative to one another. Each jaw has at least one gripping section configured in U shape. The tool has a threaded spindle that connects the clamping jaws with one another, by means of which the clamping jaws can be moved towards one another during installation of the pipe connection.

### BACKGROUND OF THE INVENTION

1. Field of the Invention

The invention relates to a tool for installation of a pipe connection that has a pipe connection sleeve and two pinch collets that can be pressed onto it. The tool has two clamping jaws oriented parallel to one another, which can move relative to one another. Each jaw has at least one gripping section configured in U shape.

2. The Prior Art

A corresponding tool is described in German Utility Model DE 93 07 957 U1, for example. This installation tool, configured as manual pliers, has two pliers parts, each of which has a handle shank, held together by an articulated connection. Each pliers part is connected, in articulated manner, with a clamping jaw. The clamping jaws are oriented parallel to one another. The clamping jaws can be moved, relative to one another, by activating the handle shanks. Each of the clamping jaws has a gripping section configured in U shape.

Corresponding installation tools are used for installation of pipe connections of air conditioning and/or cooling systems, for example. It is a disadvantage of the known installation tools that because of their configuration, which takes up a lot of space, they can be used only insufficiently, or not at all, in installation regions that are difficult to access.

### SUMMARY OF THE INVENTION

It is therefore an object of the invention to make available a tool for installation of a pipe connection, which is dimensioned in a space-saving manner and thus can be used in very flexible manner.

This object is accomplished according to the invention by a tool that has parallel movable clamping jaws and a threaded spindle that connects the clamping jaws with one another, by means of which the clamping jaws can be moved towards one another during installation of the pipe connection.

According to the invention, a tool is therefore proposed for installation of a pipe connection, which can be activated solely by way of the threaded spindle, doing without the handle shanks that are required in the state of the art. The tool is therefore configured in a clearly more space-saving manner than the previously known installation tools, and can therefore be used in a very flexible manner and easily handled even in installation regions that are difficult to access. The only thing that has to be guaranteed is that the threaded spindle can be activated in the installation position of the tool, in order to be able to move the clamping jaws towards one another for installing the pipe connection. The size of the clamping jaws can be reduced to a minimum, as long as their functionality is taken into consideration.

According to an advantageous embodiment of the invention, the threaded spindle is oriented perpendicular to the clamping jaws. This guarantees an optimal transfer of force from the threaded spindle to the clamping jaws, without the occurrence of disadvantageous shearing forces that could make activation of the tool difficult.

Another advantageous embodiment of the invention provides that the threaded spindle is mounted on one of the clamping jaws in an axially immovable manner, and on the other clamping jaw in an axially movable manner. This represents a very simple implementation of the advance mechanism and accordingly of the movement mechanism of the tool according to the invention. By activating the threaded spindle, the clamping jaw that is mounted on the threaded spindle in axially movable manner is moved relative to the clamping jaw that is mounted on the threaded spindle in axially immovable manner.

According to another advantageous embodiment of the invention, the tool has a spindle nut disposed on the threaded spindle, which engages on one of the clamping jaws, to transfer tensile and/or push forces during installation. Preferably, the spindle nut is disposed on the clamping jaw that is mounted on the threaded spindle in an axially movable manner. By activating the spindle nut, this clamping jaw is thereby moved along the threaded spindle, relative to the other clamping jaw.

Preferably, the spindle nut supports itself on the clamping jaw by way of a needle bearing or a ball bearing. This allows activation of the spindle nut and accordingly of the tool without great expenditure of force, even at great installation force.

It is furthermore proposed that the threaded spindle is connected with at least one of the clamping jaws in a torque-proof manner. Preferably, the threaded spindle is connected in a torque-proof manner with the clamping jaw on which the threaded spindle is mounted in an axially immovable manner.

According to an alternative advantageous embodiment of the invention, the threaded spindle is mounted on the clamping jaws so as to rotate about its longitudinal axis. An outside thread of the threaded spindle interacts with a corresponding inside thread that is formed on one of the clamping jaws. Rotation of the threaded spindle about its longitudinal axis thus produces a movement of the clamping jaw provided with the inside thread, along the threaded spindle. In the other clamping jaw, the threaded spindle is preferably mounted in axially immovable manner, but in rotatable manner.

It is practical if the tool has a guide rod oriented parallel to the threaded spindle, which is fixed in place in an axially immovable manner on one of the clamping jaws, and guided in an axially movable manner on the other clamping jaw. The guide rod particularly serves to prevent canting of the clamping jaws during installation of a pipe connection.

Preferably, the guide rod is connected with the clamping jaws in a centered manner. Particularly preferably, the guide rod forms an axis of rotation about which the clamping jaws can be rotated relative to one another. In the case of such an embodiment, the threaded spindle is preferably connected with the clamping jaws in a non-centered manner. Such an embodiment of the tool according to the invention allows the use of at least one clamping jaw that has a gripping section at its two ends, in each instance, and the gripping sections differ in their nominal width. Depending on the nominal width that is required for installation of the pipe connection, the clamping jaw having gripping sections of different nominal width can be rotated about the axis of rotation formed by the guide rod, in order to select the gripping section having the nominal width required for installation of the pipe connection. Preferably, the two clamping jaws have a gripping section at their two ends, and the gripping sections of each clamping jaw differ in their nominal width. In this way, the flexibility of the tool according to the invention, with regard to its installation use, is clearly increased. Alternatively or in addition to this, the gripping sections can be releasably connected with the ends of the clamping jaws, in order to be able to use gripping sections having suitable nominal widths.

The clamping jaws can optionally be connected with the threaded spindle at their two end sections. This embodiment is particularly practical if the tool has the guide rod mentioned above, which forms an axis of rotation about which the clamping jaws can be rotated relative to one another.

The tool can have at least one spacer disposed between the clamping jaws, the thickness of which is configured in such a manner that parallel orientation of the clamping jaws in a final installation position, in which the pipe connection is completely or almost completely assembled, is guaranteed. In the case of a tool having the guide rod disposed in a centered manner, and the threaded spindle connected with the clamping jaws in a non-centered manner, the spacer is preferably disposed on one of the clamping jaws on the side that lies opposite the threaded spindle, with reference to the guide rod.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a schematic representation of an exemplary embodiment of the tool according to the invention;

FIG. 2 is a schematic representation of another exemplary embodiment of the tool according to the invention; and

FIG. 3 is a schematic representation of an exemplary embodiment of a clamping jaw of the tool according to the invention.

### DETAILED DESCRIPTION OF THE EMBODIMENTS

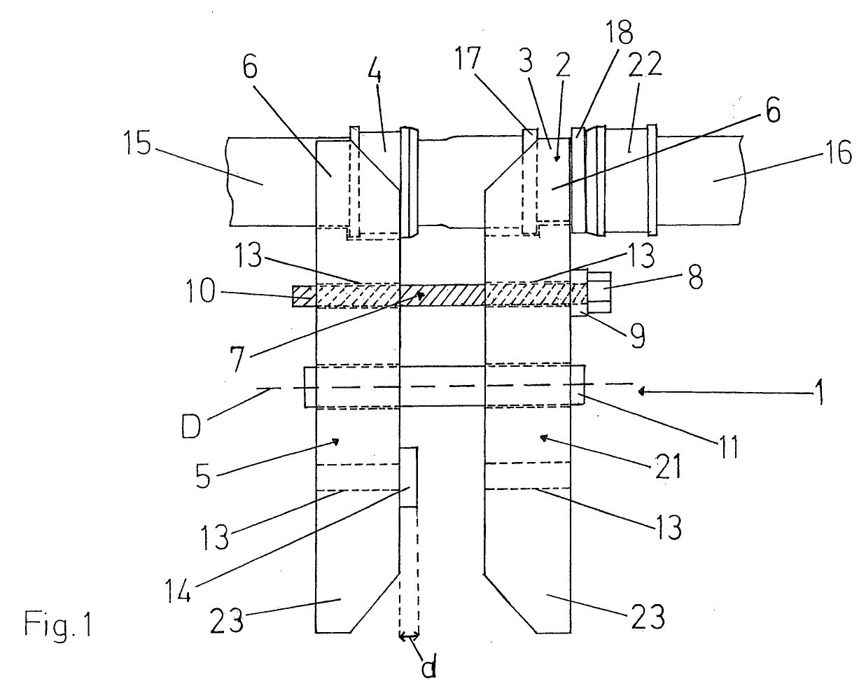

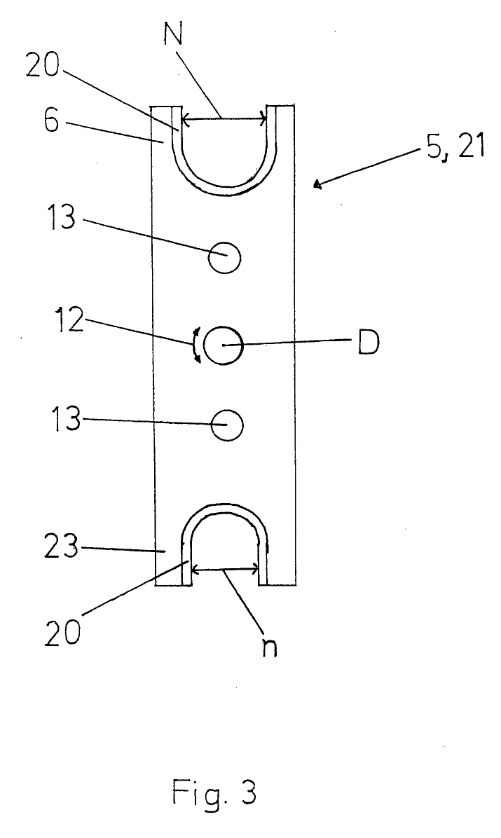

FIG. 1 is a schematic representation of an exemplary embodiment of the tool 1 according to the invention for installation of a pipe connection 2. Pipe connection 2 has a pipe connection sleeve 3 and two pinch collets 4, 22 that can be pressed onto it. Tool 1 has two clamping jaws 5, 21 oriented parallel to one another, which can move relative to one another. Each of these clamping jaws 5, 21 has two gripping sections 6, 23 configured in U shape, in each instance, at its ends, as shown in greater detail in FIG. 3. Clamping jaws 5, 21 are connected with one another by way of a threaded spindle 7, by means of which clamping jaws 5, 21 can be moved towards one another during installation of pipe connection 2. Threaded spindle 7 is oriented perpendicular to clamping jaws 5, 21. Threaded spindle 7 can rotate about its longitudinal axis, and is mounted on the right clamping jaw 21 in an axially immovable manner, and on the left clamping jaw 5 in an axially movable manner, whereby threaded spindle 7 interacts, by way of its outside thread 10, with a corresponding inside thread, not shown in any detail, in upper bore 13 of left clamping jaw 5. In this way, left clamping jaw 5 can be moved towards right clamping jaw 21, and away from it, along threaded spindle 7. A hexagonal head 8 is disposed on threaded spindle 7, which engages on right clamping jaw 21, to transfer tensile and/or push forces during installation. Hexagonal head 8 supports itself on right clamping jaw 21 by way of a bearing 9, which can be configured as a needle bearing or ball bearing.

Alternatively, threaded spindle 7 can be connected with left clamping jaw 5 in a torque-proof manner. In such an embodiment, threaded spindle 7 is mounted in right clamping jaw 21 in an axially movable manner, whereby right clamping jaw 21 can be moved in the direction of left clamping jaw 5 along threaded spindle 7, when a spindle nut that is disposed on the threaded spindle 7 is activated.

Tool 1 furthermore has a guide rod 11 oriented parallel to threaded spindle 7, which is fixed in place on one of the clamping jaws 5, 21 in an axially immovable manner, and guided on the other clamping jaw 21, 5 in an axially movable manner. Guide rod 11 is connected with the clamping jaws 5, 21 in a centered manner. It forms the axis of rotation D, about which clamping jaws 5, 21 can be rotated relative to one another, as is indicated in FIG. 3 with arrow 12. Threaded spindle 7 is connected with clamping jaws 5, 21 in a non-centered manner. The clamping jaws 5, 21 have gripping sections 6, 23 at their two ends, which differ in their nominal width, as will be explained in greater detail in connection with FIG. 3. Clamping jaws 5, 21 can optionally be connected with threaded spindle 7 at their two end sections. For this purpose, each one of clamping jaws 5, 21 has at least two non-centered bores 13.

Tool 1 has a spacer 14 disposed between clamping jaws 5, 21, the thickness d of which is configured in such a manner that the parallel orientation of clamping jaws 5, 21 in a final installation position, in which pipe connection 2 is completely or almost completely assembled, is guaranteed.

Pipe connection 2 shown in FIG. 1 shows a first application case of tool 1. In this connection, pipes 15 and 16 are pushed onto the pipe connection sleeve 3 up to a flange 17 or 18, respectively. In a subsequent work step, pinch collets 4, 22 are pressed onto pipe connection sleeve 3, one after the other, specifically also up to the flanges 17 and 18, respectively. This has already been done in the case of pinch collet 22 shown on the right. It has taken its final installation position and rests against flange 18. In order to achieve this final installation position of the left pinch collet 4, right clamping jaw 21 of tool 1 is set against flange 17, while the left clamping jaw 5 engages on the left pinch collet 4 shown on the left. By activating hexagonal head 8, clamping jaws 5, 21 are moved towards one another by means of threaded spindle 7, until left pinch collet 4 rests against flange 17 and thus has taken its final installation position. Spacer 14 is provided in order to prevent clamping jaws 5, 21 from moving relative to an axis that runs perpendicular to the plane of the drawing, and in opposite directions, towards one another, as a result of the great press-down forces that occur, while pinch collets 4, 22 are being brought into their final installation position. Such an opposite movement of clamping jaws 5, 21 would lead to the result that pressing-on of the pinch collets 4, 22 could not be ensured precisely up to flanges 17 and 18, respectively, since the forces that occur in this connection would partly lead to elastic deformation of the individual components of tool 1, and thus would not be available for the desired positioning of pinch collets 4, 22. The thickness d of spacer 14 is therefore selected in such a manner that the right clamping jaw 21 can support itself on spacer 14 when the final installation position of the left pinch collet 4 is reached. In this way, the aforementioned elastic deformations are reliably prevented, and precise installation of pipe connection 2 is possible.

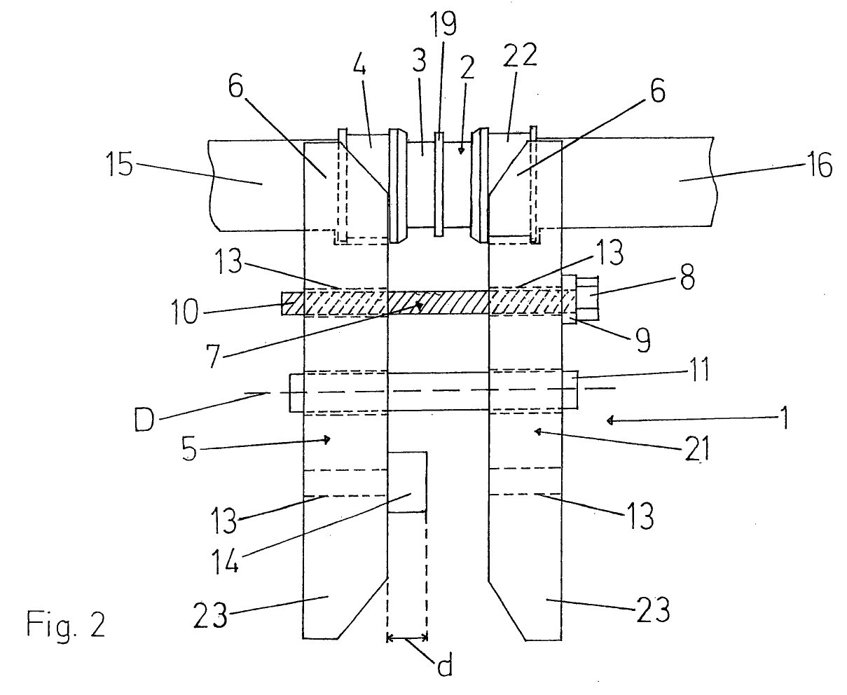

FIG. 2 shows another application of tool 1. In this connection, the same components are provided with the same reference symbols as in FIG. 1. In this application, clamping jaws 5, 21 both engage on pinch collets 4, 22, which are pressed onto pipe connection sleeve 3 up to a flange 19, i.e. moved towards one another, by activating spindle nut 8 and by way of threaded spindle 7. Here again, the thickness d of spacer 14 is selected in such a manner that right clamping jaw 21 supports itself on spacer 14 when or just before the final installation position of the pipe connection 2 is reached, in order to avoid elastic deformations of the components of tool 1, and the related disadvantages described above.

Using tool 1 according to the invention, it is possible, for example, to install pipe connections 2 having pinch collets 4, 22 and/or flanges 17 or 18, respectively, that have different outside diameters. For this purpose, at least one of the clamping jaws 5, 21 of tool 1 has two gripping sections 6, 23 configured in U shape at its two ends, whereby the two gripping sections 6, 23 of this clamping jaw 5, 21 have different nominal widths N and n, respectively, as shown in FIG. 3. If one of these gripping sections 6, 23 is used for installation of a pipe connection 2, then threaded spindle 7 can be removed from clamping jaws 5, 21, and subsequently the two clamping jaws 5, 21 can be rotated, relative to one another, about the axis of rotation D formed by guide rod 11. Subsequently, threaded spindle 7 can be introduced, once again, into bores 13 that face pipe connection 2. Alternatively or in addition, threaded spindle 7 can optionally be connected with clamping jaws 5, 21, which means that threaded spindle 7 can be inserted also into lower bores 13 in clamping jaws 5, 21, as shown in FIGS. 1 and 2, in order to use lower gripping sections 23 of clamping jaws 5, 21 for installation of a pipe connection 2. In this connection, spacer 14 can also optionally be connected with clamping jaws 5, 21, i.e. in bores 13 in them. This can be done, for example, by means of a simple plug-in connection between a clamping jaw 5, 21 and spacer 14.

FIG. 3 schematically shows an exemplary embodiment of a clamping jaw 5, 21 of tool 1 according to the invention. Clamping jaw 5, 21 has an upper gripping section 6 and a lower gripping section 23, whereby the nominal width N of upper gripping section 6 is configured to be greater than the nominal width n of lower gripping section 23. Each gripping section 6, 23 has two regions adjacent to one another, having a different nominal width. A shoulder 20 that stands perpendicular to the longitudinal axis of pipe connection 2 is disposed between these regions. The nominal width of the region having the greater nominal width corresponds essentially to the outside diameter of pipes 15 and 16. The nominal width of the region having the smaller nominal width corresponds to the outside diameter of pinch collets 4, 22, i.e. to flanges 17 and 18.

Accordingly, while only a few embodiments of the present invention have been shown and described, it is obvious that many changes and modifications may be made thereunto without departing from the spirit and scope of the invention.

What is claimed is:

1. A tool for installation of a pipe connection that has a pipe connection sleeve and two pinch collets that can be pressed onto it, the tool comprising:
two clamping jaws oriented parallel to one another and which can move relative to one another, each jaw having at least one gripping section configured in U shape; and
a threaded spindle that connects the clamping jaws with one another, said threaded spindle moving the clamping jaws towards one another during installation of the pipe connection.

2. The tool according to claim 1, wherein the threaded spindle is oriented perpendicular to the clamping jaws.

3. The tool according to claim 1, wherein the threaded spindle is mounted on one of the clamping jaws in an axially immovable manner, and on the other clamping jaw in an axially movable manner.

4. The tool according to claim 1, further comprising a spindle nut disposed on the threaded spindle, said nut engaging on one of the clamping jaws, to transfer tensile and/or push forces during installation.

5. The tool according to claim 4, wherein the spindle nut supports itself on said one clamping jaw by way of a needle bearing or a ball bearing.

6. The tool according to claim 1, wherein the threaded spindle is connected with at least one of the clamping jaws in a torque-proof manner.

7. The tool according to claim 1, wherein the threaded spindle is mounted rotatable about its longitudinal axis, and wherein an outside thread of the threaded spindle interacts with a corresponding inside thread that is formed on one of the clamping jaws.

8. The tool according to claim 1, further comprising a guide rod oriented parallel to the threaded spindle, said guide rod being fixed in place in an axially immovable manner on one of the clamping jaws, and guided in an axially movable manner on the other clamping jaw.

9. The tool according to claim 8, wherein the guide rod is connected with the clamping jaws in a centered manner.

10. The tool according to claim 8, wherein the guide rod forms an axis of rotation about which the clamping jaws can rotate relative to one another.

11. The tool according to claim 1, wherein the threaded spindle is connected with the clamping jaws in a non-centered manner.

12. The tool according to claim 1, wherein at least one of the clamping jaws has a gripping section at each of its two ends, and wherein said gripping sections have nominal widths that differ from each other.

13. The tool according to claim 1, wherein the clamping jaws can optionally be connected with the threaded spindle at their two end sections.

14. The tool according to claim 1, further comprising at least one spacer disposed between the clamping jaws, said spacer having a thickness that is selected to ensure parallel orientation of the clamping jaws in a final installation position, in which the pipe connection is completely or almost completely assembled.
